(19) United States
(12) Patent Application Publication
(10) Pub. No.: US 2021/0316564 A1
(43) Pub. Date: Oct. 14, 2021

(54) PLASMA ELECTRON BEAM TREATMENT INKJET PRINTING DEVICE

(71) Applicant: SAKATA INX CORPORATION, Osaka-shi, Osaka (JP)

(72) Inventors: Okinori NAKASHIMA, Osaka-shi, Osaka (JP); Takuya MYOSE, Osaka-shi, Osaka (JP); Jun KINJOH, Osaka-shi, Osaka (JP); Daigo SHIOZAKI, Osaka-shi, Osaka (JP)

(21) Appl. No.: 17/277,277

(22) PCT Filed: Sep. 12, 2019
(86) PCT No.: PCT/JP2019/035915

§ 371 Date: Mar. 17, 2021

(30) Foreign Application Priority Data
Sep. 27, 2018 (JP) 2018-182949

(51) Int. Cl. B41M 7/00; B41J 2/01; B41J 11/00

(52) U.S. Cl. CPC B41M 7/0081; B41J 11/0021; B41J 2/01

(57) ABSTRACT

An inkjet printing device includes: an inkjet nozzle that moves on a printing surface of a target base printing material in a direction perpendicular to a moving direction of the target base printing material and parallel with the printing surface of the target base printing material; a plasma ejection port disposed downstream of the inkjet nozzle in the moving direction of the target base printing material, for treating the printing surface of the target base printing material with a plasma; and an electron beam irradiation part disposed downstream of the plasma ejection port in the moving direction of the target base printing material, for treating the printing surface of the target base printing material with an electron beam. The device allows inks used in printing to be cured without fail even when they contain no photopolymerization initiator.

### TECHNICAL FIELD

The present invention relates to an inkjet printing device.

### BACKGROUND ART

As described in Patent Literature 1, an art of irradiating ultraviolet light at low oxygen concentration onto an ink on a target base printing material immediately after it has been inkjet-printed, to polymerize the surface layer of the ink, and then irradiating an electron beam (hereinafter also referred to as “EB”) to polymerize its deep part and thereby cure the entirety of the ink, is known.

Also, as described in Patent Literature 2, an art of applying corona discharge treatment in an ambience of below 20000 ppm in oxygen concentration to an ink on a target base printing material immediately after it has been inkjet-printed, to polymerize the surface layer of the ink, and then irradiating an electron beam to polymerize its deep part and thereby cure the entirety of the ink, is known.

While these curing means reportedly do not require compounding of a photopolymerization initiator into the ink, they do require an ambience of low oxygen concentration.

The aforementioned background arts, while allowing an energy beam-curable ink containing no photopolymerization initiator to be cured eventually and without fail, still require a region of particularly low oxygen concentration to be formed. Particularly in the case of the invention described in Patent Literature 1, ultraviolet light may have to be irradiated after all, which makes it difficult, in practice, to cure the surface layer of the energy beam-curable ink containing no photopolymerization initiator.

Furthermore, in the case of using corona discharge treatment, performing the treatment in a stable manner is difficult unless the distance between the electrodes is sufficiently reduced to around several millimeters. In this case, depending on the thickness of the printing paper and degree of vertical movement of the printing paper, the printed ink may contact the electrodes before its surface cures, and disturb the printing as a result. Also, depending on the intensity of corona discharge treatment, the surface of the paper or other target base printing material may change its property where the ink is not deposited.

### BACKGROUND ART LITERATURE

### Patent Literature

Patent Literature 1: Japanese Patent Laid-open No. 2017-132895
Patent Literature 2: Japanese Patent No. 6353618

### SUMMARY OF THE INVENTION

### Problems to be Solved by the Invention

An object of the present invention is to obtain a device that allows the ink used in printing to be cured, even when it contains no photopolymerization initiator, without modifying the property of the surface of the target base printing material.

### Means for Solving the Problems

As a result of studying in earnest to achieve the aforementioned object, the inventors of the present invention completed the invention as described below.

1. An inkjet printing device comprising:

an inkjet nozzle that moves in a direction perpendicular to a moving direction of a target base printing material and also in parallel with the surface of the target base printing material;

a plasma ejection port; and

an electron beam irradiation part located on a downstream side, in the moving direction of the target base printing material, of the inkjet nozzle and the plasma ejection port.

2. The inkjet printing device according to 1, comprising:

an inkjet printing part comprising:

the inkjet nozzle that moves in the direction perpendicular to the moving direction of the target base printing material and also in parallel with the surface of the target base printing material; and

the plasma ejection port; and

the electron beam irradiation part located on the downstream side, in the moving direction of the target base printing material, of the inkjet printing part.

3. The inkjet printing device according to 2, wherein a head equipped with at least one of the inkjet nozzles has the plasma ejection port.

4. The inkjet printing device according to 2 or 3, wherein the inkjet printing device is for multi-color printing, a/the head with inkjet nozzle is provided as an inkjet nozzle assigned to each color, and the plasma ejection port is provided on each head.

5. The inkjet printing device according to any one of 2 to 4, wherein an opening part of the plasma ejection port is not oriented facing the surface of the target base printing material.

6. The inkjet printing device according to any one of 2 to 5, wherein an/the opening part of the plasma ejection port is oriented in the moving direction of the target base printing material so that the plasma ejected from the plasma ejection port is set to be oriented in the direction in which the target base printing material moves.

7. The inkjet printing device according to any one of 2 to 6, wherein a base material that is grounded or charged with negative electricity or positive electricity is placed, in the inkjet printing part, on the opposite side of the target base printing material as viewed from the plasma ejection port, and in contact with a non-printing surface side of the target base printing material.

8. The inkjet printing device according to any one of 2 to 7, having a cover for covering the plasma ejection port.

9. The inkjet printing device according to any one of 2 to 8, comprising:

the inkjet printing part comprising the inkjet nozzle that moves in the direction perpendicular to the moving direction of the target base printing material and also in parallel with the surface of the target base printing material;

a cover provided for covering the inkjet printing part;

the plasma ejection port provided in the cover; and

the electron beam irradiation part located on the downstream side, in the moving direction of the target base printing material, of the inkjet printing part.

10. The printing device according to 9, wherein an opening part of the plasma ejection port is not oriented facing the surface of the target base printing material.

11. The printing device according to 10, wherein the opening part of the plasma ejection port is oriented in the moving direction of the target base printing material so that the plasma ejected from the plasma ejection port is set to be oriented in the direction in which the target base printing material moves.

12. The inkjet printing device according to any one of 2 to 11, wherein a base material that is grounded or charged with negative electricity or positive electricity is placed, in the inkjet printing part, on the opposite side of the target base printing material as viewed from the plasma ejection port, and in contact with the non-printing surface side of the target base printing material.

13. The inkjet printing device according to 1, comprising:

an inkjet printing part comprising the inkjet nozzle that moves in the direction perpendicular to the moving direction of the target base printing material and also in parallel with the surface of the target base printing material;

the plasma ejection port provided on the downstream side, in the moving direction of the target base printing material, of the inkjet printing part; and

the electron beam irradiation part located on the downstream side, in the moving direction of the target base printing material, of the plasma ejection port.

14. The inkjet printing device according to 13, comprising at least one set of the following combination:

the inkjet printing part that is made to discharge only one colored ink; and

the plasma ejection port provided on the downstream side, in the moving direction of the target base printing material, of the inkjet printing part;

wherein, when there are two such combinations, the two or more such combinations are arranged in parallel in the moving direction of the target base printing material.

15. The inkjet printing device according to 13 or 14, wherein the opening part of the plasma ejection port is not oriented facing the surface of the target base printing material.

16. The inkjet printing device according to any one of 13 to 15, wherein the opening part of the plasma ejection port is oriented in the moving direction of the target base printing material so that the plasma ejected from the plasma ejection port is set to be oriented in the direction in which the target base printing material moves.

17. The inkjet printing device according to any one of 13 to 16, wherein a base material that is grounded or charged with negative electricity or positive electricity is placed on the opposite side of the target base printing material as viewed from the plasma ejection port, and in contact with the non-printing surface side of the target base printing material.

18. The inkjet printing device according to any one of 13 to 17, having a cover for covering the plasma ejection port.

19. An inkjet printing device comprising:

inkjet nozzles of a line-head type for printing one or more colored inks; and plasma ejection ports, each provided for each color-specific nozzle on a downstream side in the moving direction of a target base printing material.

20. An inkjet printing device comprising:

inkjet nozzles of a line-head type for printing one or more colored inks; and

plasma ejection ports, each provided for each set of nozzles for printing one or more colors on a downstream side, in the moving direction of a target base printing material, as viewed from the line-head nozzle.

### Effects of the Invention

According to the printing device proposed by the present invention, printed ink dots from inkjet printing are cured by atmospheric-pressure plasma at least on the surface, and then irradiated with an electron beam (EB) and cured, so that the dots will be cured with certainty both on the surface and inner part.

Also, an object of the present invention is to provide a device that cures the surface of ink dots with atmospheric-pressure plasma after each color has been printed, so that the dots of different colored inks will not smudge even when overlaid and thus high-quality image can be achieved as a result.

In addition, an object of the present invention is to provide a device that irradiates atmospheric-pressure plasma to actively cure inks, while also preventing the paths of inks from being disturbed or the shapes of printed inks from being disturbed by air flows on the target printing surface.

### BRIEF DESCRIPTION OF THE DRAWINGS

FIG. 1 A schematic view of a cross-section of a remote atmospheric-pressure plasma generation part.

FIG. 2-1 A drawing in which inkjet nozzles are provided as one piece with plasma ejection ports.

FIG. 2-2 A drawing in which inkjet nozzles are provided as one piece with plasma ejection ports.

FIG. 2-3 A drawing in which inkjet nozzles are provided as one piece with a plasma ejection port.

FIG. 2-4 A drawing in which inkjet nozzles are provided as one piece with plasma ejection ports.

FIG. 3-1 A drawing in which an inkjet nozzle is provided as one piece with a plasma ejection port.

FIG. 3-2 A drawing in which an inkjet nozzle is provided as one piece with a plasma ejection port.

FIG. 3-3 A drawing in which an inkjet nozzle is provided as one piece with a plasma ejection port.

FIG. 4 A drawing in which an inkjet nozzle is provided separately from plasma ejection ports.

FIG. 5 A drawing showing only a plasma ejection device, wherein an inkjet nozzle is provided separately from a plasma ejection port.

### DESCRIPTION OF THE SYMBOLS

10 - - - Atmospheric-pressure plasma generation device
11 - - - A pair of electrodes
12 - - - Insulator body
21 - - - Plasma ejection port
30 - - - Front-end atmospheric-pressure plasma treatment device
31 - - - Discharge electrode
32 - - - Insulating material
33 - - - Plasma ejection tube
34 - - - Backup roller
36 - - - Cover
40 - - - Downstream atmospheric-pressure plasma treatment device
41 - - - Discharge electrode
42 - - - Insulating material
43 - - - Plasma ejection tube
44 - - - Backup roller
45 - - - Cover
G - - - Atmospheric-pressure plasma generation gas
P - - - Atmospheric-pressure plasma
S - - - Target base printing material
N - - - Inkjet nozzle

### MODE FOR CARRYING OUT THE INVENTION

The device proposed by the present invention is explained in detail below.

### <Inkjet Printing Part>

For the inkjet printing part under the present invention, a structure comprising any of various known inkjet nozzles, or a structure comprising a nozzle conforming to any known inkjet method, may be adopted.

And, for the inkjet printing part, which prints on coated paper, plain paper, various resin films, laminate films having metal layers and metal compound layers, and other known target base printing materials that can be inkjet-printed, one based on any known operating principle may be adopted.

Such inkjet printing part may be fitted with an inkjet nozzle in such a way that it moves in the direction perpendicular to the moving direction of the target base printing material and in parallel with the surface of the target base printing material, or may have a fixed inkjet nozzle like a line-head type.

Here, it should be noted that, while the target base printing material to be conveyed can be supported with backup rollers that turn at a constant speed, backup rollers need not be provided.

The inkjet nozzle, or nozzles, is/are constituted by one or more nozzles corresponding to one or more colors. Printing data is calculated to obtain an accurate printing location for each color (location at which the ink is ejected from each nozzle), after which an ejection timing for each colored ink from each inkjet nozzle is obtained to allow for printing at the printing location, and inkjet printing is performed based on this calculation result.

(Plasma Ejection Port (Provided as One Piece with Inkjet Nozzle)

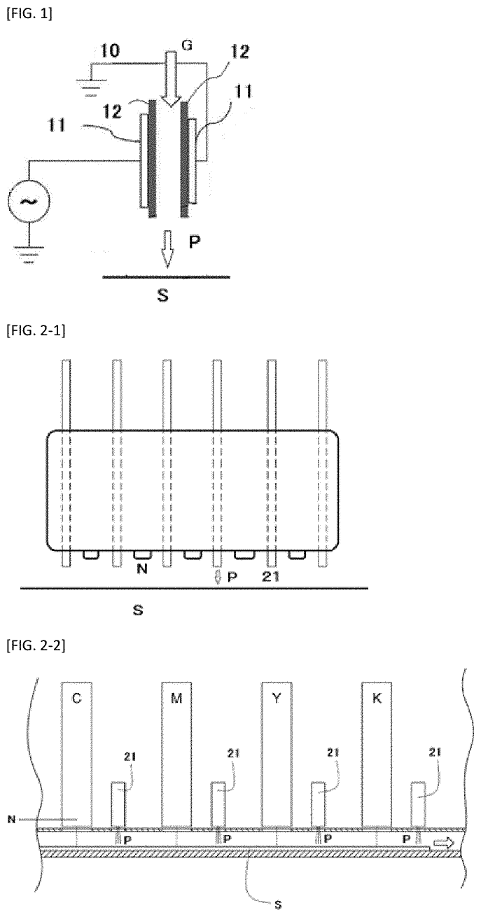

The plasma ejection port under the present invention is designed to introduce atmospheric-pressure plasma formed by the atmospheric-pressure plasma generation device 10 shown in FIG. 1, and irradiate the atmospheric-pressure plasma to cure the surface of ink dots printed on the target base printing material.

The atmospheric-pressure plasma generation device 10 shown in FIG. 1 uses a plasma treatment device comprising a discharge space with an outlet, and a pair of discharge electrodes 11 with insulator bodies 12 facing each other over a spacing of approx. 0.5 to 5.0 mm so that they can generate an electric field in this discharge space. This plasma treatment device is such that plasma generation gas G is supplied to the discharge space, while the pressure inside the discharge space is maintained near atmospheric pressure, and further, a voltage is applied to the pair of electrodes 11 also for the discharge, and when a voltage exceeding the discharge starting voltage is further applied to generate discharge in the discharge space, atmospheric-pressure plasma P will generate in the discharge space.

A plasma ejection port for performing this atmospheric-pressure plasma irradiation may be provided on the same head as an inkjet nozzle under the serial head method, or it may be provided separately from the inkjet head so that it can be moved, etc., as desired. at will. Also, a plasma ejection port that ejects atmospheric-pressure plasma may be provided as one piece with an inkjet nozzle under the line head method.

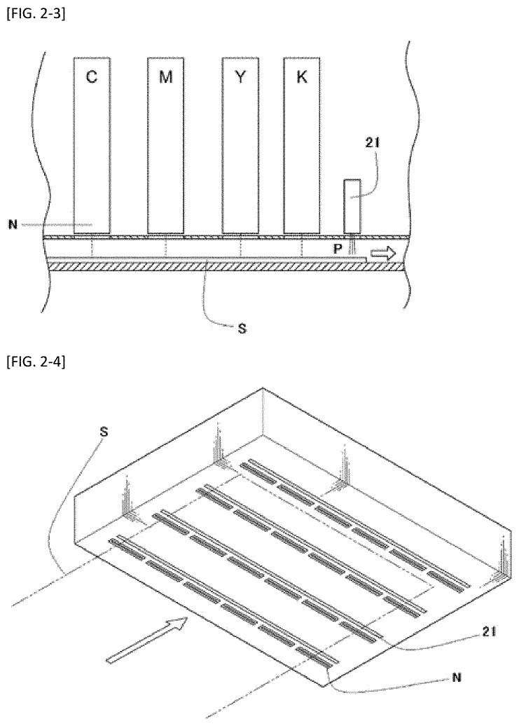

Under both the serial head method and the line head method, a configuration in which a plasma ejection port is provided on the same head as an inkjet nozzle is possible, where an inkjet nozzle for a given color is provided on the same head as a plasma ejection port, and multiple such color-specific heads are installed. Also, inkjet nozzles N assigned to multiple colors, respectively, may be provided on the same head as plasma ejection ports 21, as shown in FIG. 2-1. For example, a plasma ejection port 21 for each color may be provided on the downstream side of a nozzle N for each of CMYK colors, as shown in FIG. 2-2.

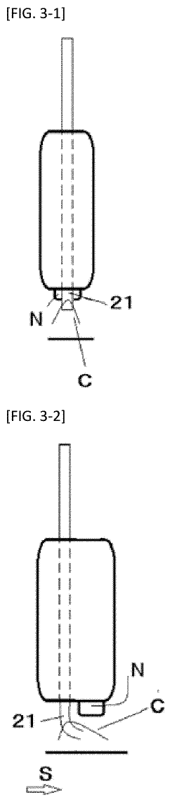

Furthermore, as shown in FIG. 2-3, a plasma ejection port 21 may be provided downstream of multiple CMYK inkjet nozzles so that printing with these inkjet nozzles can be followed by a single treatment with atmospheric-pressure plasma P.

It should be noted that the layouts shown in FIGS. 2-2 and 2-3 can be provided under both the serial head method and the line head method.

Here, the basic structure of the line head method is one where, as shown in FIG. 2-4 as a view from diagonally below, multiple inkjet nozzles N and plasma ejection ports 21 are provided above the target base printing material S in a manner extending across the width direction of the target base printing material.

Furthermore, a cover C for covering each plasma ejection port 21 may be provided and the plasma ejection port may be provided in a manner oriented into the cover so as to increase the concentration of atmospheric-pressure plasma in the ambience inside the cover.

Also, the atmospheric-pressure plasma used under the present invention includes all gases resulting from the plasma modification of material gases.

When each plasma ejection port itself is provided between or near inkjet printing nozzles for different colors and moves with these nozzles as one piece, it will irradiate atmospheric-pressure plasma onto inks immediately after they have been printed, and therefore one that irradiates atmospheric-pressure plasma over a range of preferably 1 to 10 mm, or more preferably 1 to 5 mm, in diameter may be adopted.

During printing, the inkjet nozzles may be moved back and forth with respect to the surface of the target base printing material. In this case, a nozzle that ejects atmospheric-pressure plasma may be provided between each pair of color-specific nozzles among the inkjet nozzles for multi-color printing. Furthermore, not only between color-specific nozzles, but nozzles that eject atmospheric-pressure plasma may also be provided, one each, on the outer sides (outer sides in the width direction of the target base printing material) of the nozzles positioned at both ends of the arranged color-specific nozzles.

Similarly, when inkjet nozzles are provided based on the line head method, a plasma ejection port may be provided between each pair of color-specific nozzles among the inkjet nozzles for multi-color printing, or in such a way that it can eject atmospheric-pressure plasma onto multiple colored inks after the multiple colored inks have been printed.

FIG. 3-1 is a cross-sectional view of the device in FIG. 2-1 as viewed from side. In FIG. 3, the plasma ejection port 21 is provided in such a way that atmospheric-pressure plasma will be ejected in the same direction as the inkjet nozzle N. A device having this structure can still print and cure inks sufficiently. It should be noted that a cover C for covering the plasma ejection port 21 may be provided.

However, cured inks must not collect at the opening part of the inkjet nozzle N due to the atmospheric-pressure plasma ejected from the plasma ejection port 21 that ejects atmospheric-pressure plasma. Accordingly, the atmospheric-pressure plasma to be ejected from the plasma ejection port 21 that ejects atmospheric-pressure plasma must be ejected from the plasma ejection port 21 for atmospheric-pressure plasma which is provided in a manner described in A or B below, so that it will contact uncured inks deposited on the surface of the target base printing material S but will not contact the inkjet nozzle N:

A. As shown in FIG. 3-2, the plasma ejection port 21 that ejects atmospheric-pressure plasma is placed on the upstream side, in the moving direction of the target base printing material S, of the inkjet nozzle N, at a position as close or closer to the target base printing material S as/than the inkjet nozzle N so that atmospheric-pressure plasma will be ejected in the same direction as the moving direction of the target base printing material. And, the plasma ejection port 21 that ejects atmospheric-pressure plasma can be provided in a manner oriented to eject atmospheric-pressure plasma onto inks that have just been printed but no longer have the position relationship of facing the inkjet nozzle N because the inkjet nozzle N has moved.

B. As shown in FIG. 3-3, the plasma ejection port 21 that ejects atmospheric-pressure plasma is placed on the downstream side, in the moving direction of the target base printing material S, of the inkjet nozzle N, at a position as close or closer to the target base printing material S as/than the inkjet nozzle N so that atmospheric-pressure plasma will be ejected in the opposite direction to the moving direction of the target base printing material. And, the plasma ejection port 21 that ejects atmospheric-pressure plasma can be provided in a manner oriented to eject atmospheric-pressure plasma onto inks that have just been printed but no longer have the position relationship of facing the inkjet nozzle N because the inkjet nozzle N has moved.

If the device in FIG. 3-2 or FIG. 3-3 above is adopted, atmospheric-pressure plasma can be irradiated immediately after an ink having a given color has deposited on the target base printing material according to the movement of the inkjet nozzle N and discharge of the colored ink, and also because atmospheric-pressure plasma does not contact the inkjet nozzle N, the cured ink does not deposit/collect on the inkjet nozzle N.

In the cases of FIG. 3-2 and FIG. 3-3 above, atmospheric-pressure plasma can be irradiated on each colored ink at a timing immediately after its ejection and before the next colored ink is ejected.

As a result, the next colored ink, when ejected, will not mix with the previous colored ink whose surface has been cured to some degree by atmospheric-pressure plasma, and consequently the printed outlines will become clearer.

It should be noted that the inkjet printing device may be such that, as shown in FIG. 2, ink jet nozzles N for all colors used in printing may be provided on the print head and multiple plasma ejection ports 21 corresponding to the respective colors may also be provided on the same head, or ink nozzles for multiple colors representing only a part of colors such as three or four colors may be provided on one head together with a plasma ejection port(s) 21 for curing these colored inks, and one or more such heads may be provided along with heads that each represent a different ink color, so that, as a whole, inks of all colors can be ejected and the surface of the respective inks will be cured with plasma.

(Plasma Ejection Port (Provided Separately from Inkjet Nozzle))

Under the present invention, the plasma ejection port may be provided separately from the inkjet nozzle head. In this case, one or more heads, each printing only one color, will be placed along the moving direction of the target base printing material. And, one or more plasma ejection devices will be provided, each corresponding to each head and, on the downstream side of each head.

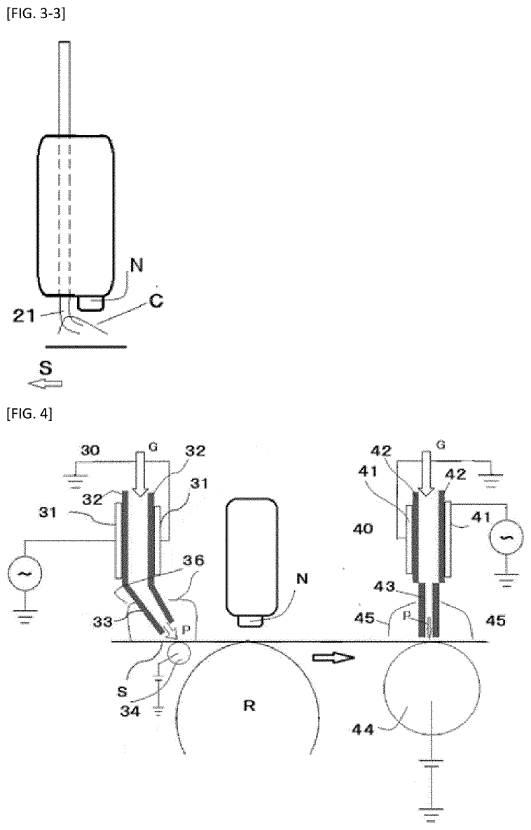

In FIG. 4, the inkjet nozzle N ejects only one colored ink. If multi-color printing is performed, nozzles for the necessary number of colors, each corresponding to this inkjet nozzle N, are to be provided downstream of the arrow representing the moving direction of the target base printing material S. FIG. 4 is a drawing that shows only one of these colors, and the inkjet nozzle N is provided at a position facing the backup roller R provided as necessary.

After the first colored ink has been printed by this inkjet nozzle N, it is conveyed to a downstream atmospheric-pressure plasma treatment device 40 similar to the plasma treatment device shown in FIG. 1. Here, a plasma treatment device comprising a discharge space, into which atmospheric-pressure plasma generation gas G is introduced, and which has an outlet and is formed by an insulating material 42, as well as discharge electrodes 41 that are facing each other over a spacing of approx. 0.5 to 5.0 mm to generate an electric field in this discharge space, is used. This plasma treatment device is such that plasma generation gas G is supplied to the discharge space, while the pressure inside the discharge space is maintained near atmospheric pressure, and a voltage is applied to the discharge electrodes 41, and when a voltage exceeding the discharge starting voltage is further applied to generate discharge in the discharge space, atmospheric-pressure plasma P will generate in the discharge space.

And, the generated atmospheric-pressure plasma P travels through a plasma ejection tube 43 and is irradiated on the ink on the target base printing material. Here, a cover 45 may be provided to increase the concentration of atmospheric-pressure plasma inside the cover 45.

When inkjet printing is performed based on the line head method, a plasma treatment device may be provided for, and on the downstream side of, each head conforming to the line head method and used for printing one colored ink, or a plasma treatment device may be provided for, and on the downstream side of, each head used for printing two or more colored inks. And, a plasma treatment device may be provided on the downstream side of the foregoing so that, once all colored inks have been printed, atmospheric-pressure plasma can be ejected onto all of the colored inks.

Also, a backup roller 44 may be provided on the opposite side of the plasma ejection tube 43, where this backup roller is grounded or an electric charge opposite to that carried by the atmospheric-pressure plasma is applied to it, so that atmospheric-pressure plasma will exist on the surface of the target base printing material S at high concentration.

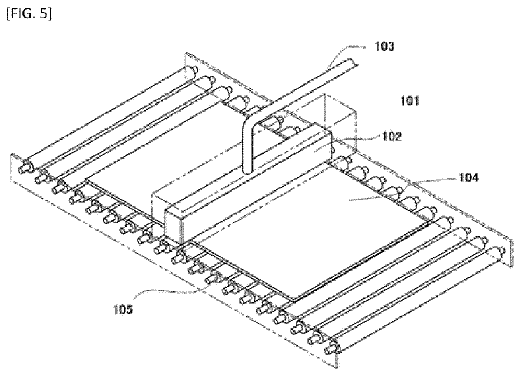

It should be noted that FIG. 5 shows a device that ejects atmospheric-pressure plasma using an atmospheric-pressure plasma introduction tube 103 and a nozzle 102 provided at its tip and thereby treats the ink on a target base printing material 104 on rollers 105, and such device constitution may be adopted with the plasma ejection tube 43 fixed, and the nozzle opening part designed as a slit, so that the moving target base printing material can be treated over its entire width.

Or, the movement of the inkjet nozzle N in the width direction of the target base printing material may be delayed by the time it takes for the target base printing material to move from the inkjet nozzle N to the downstream atmospheric-pressure plasma treatment device 40, while the plasma ejection tube 43 is moved in the same manner as the inkjet nozzle N, so that atmospheric-pressure plasma will be irradiated primarily on the ink printed by the inkjet nozzle N.

And, although this is not illustrated, the aforementioned printing with an inkjet ink using the inkjet nozzle N shown in FIG. 4, and the surface curing of the printed ink using the downstream atmospheric-pressure plasma treatment device 40, are considered as a set and such sets are provided in the same number as the colors required for overall printing.

In FIG. 4, a front-end atmospheric-pressure plasma treatment device 30 may be provided upstream of the inkjet nozzle N. This front-end atmospheric-pressure plasma treatment device 30 is used to plasma-treat the surface of the target base printing material prior to printing. As a result of such treatment by the front-end atmospheric-pressure plasma treatment device 30, plasma species still remain on the surface of the target base printing material at the time of printing. This means that, when inkjet printing is performed using the inkjet nozzle N, these groups charged by plasma treatment will remain and allow the interior of the printed ink to cure slightly after printing.

For the front-end atmospheric-pressure plasma treatment device 30 that shares a common basic constitution with the downstream atmospheric-pressure plasma treatment device 40, a plasma treatment device comprising a discharge space, into which atmospheric-pressure plasma generation gas G is introduced, and which has an outlet and is formed by an insulating material 32, as well as discharge electrodes 31 that are facing each other over a spacing of approx. 0.5 to 5.0 mm to generate an electric field in this discharge space, is used.

This plasma treatment device is such that plasma generation gas G is supplied to the discharge space, while the pressure inside the discharge space is maintained near atmospheric pressure, and a voltage is applied to the discharge electrodes 31, and when a voltage exceeding the discharge starting voltage is further applied to generate discharge in the discharge space, atmospheric-pressure plasma P will generate in the discharge space.

And, the generated atmospheric-pressure plasma P travels through a plasma ejection tube 33 and irradiates the ink on the target base printing material. Here, a cover 36 may be provided to increase the concentration of atmospheric-pressure plasma inside the cover 36.

Also, a backup roller 34 may be provided on the opposite side of the plasma ejection tube 33, where this backup roller is grounded or an electric charge opposite to that carried by the atmospheric-pressure plasma is applied to it, so that atmospheric-pressure plasma will exist on the surface of the target base printing material S at high concentration.

### (Installation of Device for Grounding or Charging)

For each inkjet nozzle and/or nozzle that ejects atmospheric-pressure plasma, a backup roller or bar that supports the non-printing surface of the target base printing material may be provided at a position facing the nozzle via the target base printing material. And, this backup roller or bar may be grounded or charged to the polarity opposite to the polarity of the plasma particles beforehand, so that an electric charge that attracts atmospheric-pressure plasma and improves the plasma density at the ink surface on the target base non-printing material can be applied to cause the plasma ejected from the plasma ejection port to change its direction and hit the ink on the target base printing material.

Also, a small cover may be provided in a manner enclosing the plasma ejection port and uncured ink on the target base printing material, so that plasma can be ejected into the cover to cause the plasma present inside the cover to move toward the top of the target base printing material.

This way, air flows containing plasma are kept from directly blowing against the ink, which can reduce the possibility of individual ink dots or their outlines from spreading as a result of air flows blowing against the uncured ink on the target base printing material.

Also, by providing such backup roller or bar, the density of atmospheric-pressure plasma can be lowered simultaneously in the ambience of the inkjet nozzle and its surroundings. As a result, depositing/collection of cured ink on the inkjet nozzle can be prevented.

(Atmospheric-pressure Plasma Generation Device)

For the plasma generation device that supplies plasma to the plasma ejection port, a remote atmospheric-pressure plasma generation device may be adopted. Plasma is a high-energy gas that generates when discharge is caused by applying high voltage between electrodes. Atmospheric-pressure plasma is a type of plasma generated under atmospheric pressure, and normally used for such purposes as hydrophilizing the surfaces of material.

For such device, a plasma treatment device comprising a discharge space with an outlet, as well as discharge electrodes facing each other over a spacing of approx. 0.5 to 5.0 mm to generate an electric field in this discharge space, like the one shown in FIG. 1, for example, is used. This plasma treatment device is such that plasma generation gas G is supplied to the discharge space, while the pressure inside the discharge space is maintained near atmospheric pressure, and a voltage is applied to the discharge electrodes 31, and when a voltage exceeding the discharge starting voltage is further applied to generate discharge in the discharge space, plasma will generate in the discharge space.

Molded products can be plasma-treated by blowing against them a gas flow containing such plasma P jetted from the outlet. For such plasma generation device, the RT series or APT series manufactured by Sekisui Chemical Co., Ltd., any appropriate plasma treatment device offered by Yamato Material Co., Ltd., or the like, or any of plasma generation devices used with the devices described in Japanese Patent Laid-open No. 2004-207145, Japanese Patent Laid-open No. Hei 11-260597, and Japanese Patent Laid-open No. Hei 3-219082, may also be used.

Also, for the gases used for atmospheric-pressure plasma, air, oxygen, nitrogen, etc., may be adopted.

It should be noted that the aforementioned spacing between the electrodes depends on the applied voltage, and a high-frequency, pulse-wave, microwave, or other electric field is applied to the electrodes to generate plasma.

Above all, preferably pulse waves are applied in consideration of the fact that the time needed for an electric field to rise and fall (rise and fall refer to voltage increasing or decreasing continuously) is preferably short. Here, the time needed for an electric field to rise and fall is preferably 10 μs or shorter, or more preferably 50 ns to 5 μs.

The electric field intensity that generates between the electrodes in the plasma generation device is 1 kV/cm or higher or preferably 20 kV/cm or higher, and/or no higher than 1000 kV/cm or preferably no higher than 300 kV/cm.

Also, when an electric field is applied using pulse waves, their frequency is preferably 0.5 kHz or higher, but it may be around 10 to 20 MHz, or around 50 to 150 MHz.

Furthermore, the electric power applied between the electrodes is 40 W/cm or lower, or preferably 30 W/cm or lower.

It is better that the aforementioned electrodes do not come in direct contact with the gas, in order to achieve stable plasma discharge. For this reason, desirably the electrode surface is coated or otherwise covered with an insulating film using any known means. Such insulating film may be quartz, alumina, or other glass material, or ceramic material, for example. Depending on the situation, barium titanate, silicon oxide, aluminum nitride, silicon nitride, silicon carbide, or other dielectric body with a dielectric constant of 2000 or lower may also be adopted.

A remote atmospheric-pressure plasma irradiation/curing part such as those discussed above is one, for example, comprising an atmospheric-pressure plasma generation part, a unit including a plasma irradiation nozzle, etc., and a power supply part, among the aforementioned known devices. Based on the above device, multiple parts that eject atmospheric-pressure plasma may further be arranged in their width direction, or each nozzle may further be shaped as a slit, in order to treat the target base printing material uniformly in the width direction.

A schematic view of a cross-section of such remote atmospheric-pressure plasma generation part 10 is shown in FIG. 1. In FIG. 1, atmospheric-pressure plasma generation gas G passes between a pair of electrodes 11, one of which is grounded and which have a layer made of an insulator body 12, etc., formed on their surface, and as it passes, the gas G is turned into plasma by the voltage applied between the electrodes. While FIG. 1 shows an air flow containing atmospheric-pressure plasma P directly contacting the printed surface of the target base printing material S, the atmospheric-pressure plasma need not make direct contact.

It should be noted that the atmospheric-pressure plasma ejected from the nozzle that ejects atmospheric-pressure plasma may irradiate beforehand the printing surface of the target base printing material to be supplied to the inkjet nozzle, on the upstream side of the inkjet nozzle. This allows the atmospheric-pressure plasma to remain briefly on the printing surface of the target base printing material, so that inkjet printing can be performed while the plasma still remains. As a result, the ink that has deposited on the surface of the target base printing material can be cured, albeit slightly, at the deposited part.

### <Electron Beam Irradiation Part>

The function of the electron beam irradiation part under the present invention is to act on the colored inks whose surface has been cured by the irradiation of atmospheric-pressure plasma on the upstream thereof, either concurrently with inkjet printing or thereafter, using the plasma ejection port provided as one piece with the inkjet nozzle, or plasma ejection port provided separately from the inkjet nozzle, and completely cure the inks internally and externally in their entirety. Adopting the electron beam irradiation part as described above, in combination with the adoption of atmospheric-pressure plasma ejection, eliminates the need for the inkjet ink composition to contain a polymerization initiator or related auxiliary agents, etc. Furthermore, high-contrast images can be formed without causing the boundaries of adjacent colors to smudge.

As for the electron beam generation device that constitutes the electron beam irradiation part, any known device may be adopted. And, an introduction/irradiation device for irradiating the electron beam generated by the electron beam generation device, over the ink on the target base printing material, is provided.

Also, the ambience in which to irradiate the electron beam is preferably one of nitrogen, rare gas, or other inert gas, in the interest of facilitating the curing.

And, the target base printing material must be passed through the electron beam irradiation part in such a way that the electron beam generated by this electron beam generation device will be irradiated uniformly over the ink on the surface of the target base printing material. Inside the electron beam irradiation part, for example, the electron beam can be irradiated on the printing surface of the target base printing material in a manner irradiating in the shape of a curtain. It should be noted that an appropriate level of the acceleration voltage of the electron beam, which can be changed in a timely manner according to the specific gravity and film pressure of the ink, is 20 to 300 kV. Preferably the irradiation quantity of the electron beam is in a range of 0.1 to 20 Mrad.

Such electron beam irradiation part, in combination with the irradiation of atmospheric-pressure plasma, can cure energy beam-curable inkjet printing inks. Furthermore, there is no need to compound any polymerization initiator, curing agent, auxiliary polymerization initiation agent, etc., in the inks beforehand. The inks can be cured sufficiently without having to compound these components into the ink.

### EXAMPLES

By supplying a polyethylene terephthalate film of 21 cm in width to a line-type inkjet printing device so that a printing speed of 12 m/min would be achieved, each of the compositions of Examples and Comparative Examples as shown in Table 1 below was printed and then cured under the conditions indicated under the applicable Example or Comparative Example. In the table, the compounding quantities of compositions are expressed in mass.

It should be noted that “Y” in “Plasma curing between colors with gas species N2” indicates that, every time an inkjet printing ink of each color had been printed, an atmospheric-pressure plasma whose gas species was nitrogen gas was irradiated from a slit of 300 m in width at a gas flow rate of 30 L/min. “Y” in “EB irradiation, 30 kGray, 90 kV” indicates that, after all colors had been printed, an electron beam generated at a voltage of 90 kV was irradiated on the inks to 30 kGray in a nitrogen gas-purged ambience.

(Smudging between Colors)

◯: Based on visual inspection, smudging did not occur between different colors adjacent to each other and the outlines remained clear.

X: Based on visual inspection, occurrence of smudging was confirmed between different colors adjacent to each other.

### (Removal of Coating Film)

◯: The coating film was not removed after it was rubbed 10 times with a cotton swab.

X: The coating film was removed when it was rubbed 10 times with a cotton swab.

### (Tackiness)

◯: When the coating film surface was touched with a finger and the condition of the coating film surface was visually observed, no tackiness was found.

X: When the coating film surface was touched with a finger and the condition of the coating film surface was visually observed, tackiness was found.

TABLE 1

| | Examples | | | | | | | Comparative Examples | | | | |
|---|---|---|---|---|---|---|---|---|---|---|---|---|
| | 1 | 2 | 3 | 4 | 5 | 6 | 7 | 1 | 2 | 3 | 4 | 5 |
| Pigment Blue 15:4 | 2.0 | | | | 2.0 | | | 2.0 | | 2.0 | 2.0 | 2.0 |
| Pigment Red 122 | | 3.6 | | | | | | | 3.6 | | | |
| Pigment Yellow 180 | | | 2.4 | | | | | | | | | |
| Carbon black | | | | 1.2 | | | | | | | | |
| Pigment dispersant: Solperse | 0.8 | 1.4 | 1.0 | 0.5 | 0.8 | | | 0.8 | 1.4 | 0.8 | 0.8 | 0.8 |
| 39000 | | | | | | | | | | | | |
| Self-dispersive cyan dispersion | | | | | | | 10.0 | | | | | |
| Pig. 20% | | | | | | | | | | | | |
| Benzyl acrylate | 10.2 | 16.0 | 14.6 | 7.3 | 10.2 | 12.0 | | 10.2 | 16.0 | 10.2 | 10.2 | 10.2 |
| 4-hydroxybutyl acrylate | 12.0 | 12.0 | 12.0 | 12.0 | 12.0 | 12.0 | 16.0 | 12.0 | 12.0 | 12.0 | 12.0 | 12.0 |
| PO-modified NPGDA | 20.0 | 12.0 | 15.0 | 24.0 | 11.0 | 11.0 | | 20.0 | 12.0 | 11.0 | 20.0 | 20.5 |
| EO(3)-modified | 10.0 | 10.0 | 10.0 | 10.0 | 10.0 | 20.0 | 5.5 | 10.0 | 10.0 | 10.0 | 10.0 | 10.0 |
| trimethylolpropane triacrylate | | | | | | | | | | | | |
| Phenoxyethyl acrylate | 10.0 | 10.0 | 10.0 | 10.0 | 10.0 | 10.0 | | 10.0 | 10.0 | 10.0 | 10.0 | 10.0 |
| Isobornyl acrylate | 24.5 | 24.5 | 24.5 | 24.5 | 24.5 | 24.5 | | 24.5 | 24.5 | 24.5 | 24.5 | 24.5 |
| Vinyl caprolactam | 10.0 | 10.0 | 10.0 | 10.0 | 10.0 | 10.0 | | 10.0 | 10.0 | 10.0 | 10.0 | 10.0 |
| Acryloyl morpholine | | | | | | | 15.0 | | | | | |
| PEG400 diacrylate | | | | | | | 20.0 | | | | | |
| RO membrane-purified water | | | | | | | 33.0 | | | | | |
| TPO | | | | | 6.0 | | | | | 6.0 | | |
| Irgacure 184 | | | | | 2.0 | | | | | 2.0 | | |
| DETX | | | | | 1.0 | | | | | 1.0 | | |
| BYK 333 | 0.5 | 0.5 | 0.5 | 0.5 | 0.5 | 0.5 | 0.5 | 0.5 | 0.5 | 0.5 | 0.5 | |
| Total | 100 | 100 | 100 | 100 | 100 | 100 | 100 | 100 | 100 | 100 | 100 | 100 |
| Plasma curing between colors | Y | Y | Y | Y | Y | Y | Y | N | N | N | Y | N |
| with gas species N2 | | | | | | | | | | | | |
| EB irradiation, 30 kGray, 90 kV | Y | Y | Y | Y | Y | Y | Y | Y | Y | Y | N | Y |
| Smudging between colors | ∘ | ∘ | ∘ | ∘ | ∘ | ∘ | ∘ | x | x | x | ∘ | x |
| Removal of coating film | ∘ | ∘ | ∘ | ∘ | ∘ | ∘ | ∘ | ∘ | ∘ | ∘ | x | ∘ |
| Tackiness | ∘ | ∘ | ∘ | ∘ | ∘ | ∘ | ∘ | ∘ | ∘ | ∘ | x | ∘ |

According to the Examples above, the device proposed by the present invention was able to print in a manner not causing smudging between colors at points where different colors were contacting each other, and also in a manner free from removal of coating film or tackiness.

By contrast, according to Comparative Examples 1 to 3 and 5 where plasma curing was not performed between colors, smudging occurred between different colors that were contacting each other. Also, according to Comparative Example 4 where EB irradiation was not performed, printing resulted in removal of coating film and tackiness.

1. An inkjet printing device comprising:
an inkjet nozzle that moves on a printing surface of a target base printing material in a direction perpendicular to a moving direction of the target base printing material and parallel with the printing surface of the target base printing material;
a plasma ejection port disposed downstream of the inkjet nozzle in the moving direction of the target base printing material, for treating the printing surface of the target base printing material with a plasma; and
an electron beam irradiation part disposed downstream of the plasma ejection port in the moving direction of the target base printing material, of the inkjet nozzle and the plasma ejection port, for treating the printing surface of the target base printing material with an electron beam.

2. The inkjet printing device according to claim 1, wherein
the inkjet nozzle and the plasma ejection port are integrated to constitute an inkjet printing part.

3. The inkjet printing device according to claim 2, wherein a head equipped with at least one of the inkjet nozzles has the plasma ejection port.

4. The inkjet printing device according to claim 2, wherein the inkjet printing device is for multi-color printing, a head with the inkjet nozzle is provided as an inkjet nozzle assigned to each color, and the plasma ejection port is provided on each head.

5. The inkjet printing device according to claim 2, wherein an opening part of the plasma ejection port is oriented facing away from the printing surface of the target base printing material.

6. The inkjet printing device according to claim 2, wherein an opening part of the plasma ejection port is oriented in the moving direction of the target base printing material so that a plasma ejected from the plasma ejection port is set to be oriented in the direction in which the target base printing material moves.

7. The inkjet printing device according to claim 2, wherein a base material that is grounded or charged with negative electricity or positive electricity is placed, under the inkjet printing part, on a side of a non-printing surface opposite to the printing surface of the target base printing material in a manner contacting the non-printing surface side of the target base printing material when the target base printing material moves under the inkjet printing part.

8. The inkjet printing device according to claim 2, having a cover for covering the plasma ejection port.

9. The inkjet printing device according to claim 2, further comprising:
a cover provided for covering the inkjet printing part, wherein the plasma ejection port is provided in the cover.

10. The inkjet printing device according to claim 9, wherein an opening part of the plasma ejection port is oriented facing away from the printing surface of the target base printing material.

11. The inkjet printing device according to claim 10, wherein the opening part of the plasma ejection port is oriented in the moving direction of the target base printing material so that a plasma ejected from the plasma ejection port is set to be oriented in the direction in which the target base printing material moves.

12. (canceled)

13. The inkjet printing device according to claim 1, wherein
the inkjet nozzle constitutes an inkjet printing part disposed independently of plasma ejection port.

14. The inkjet printing device according to claim 13, wherein
the inkjet printing part is made to discharge only one colored ink; and
one plasma ejection port as the plasma ejection port is provided for one inkjet printing part as the inkjet printing port, constituting a combination
wherein one or more such combinations are arranged in parallel in the moving direction of the target base printing material.

15. The inkjet printing device according to claim 13, wherein an opening part of the plasma ejection port is oriented facing away from the printing surface of the target base printing material.

16. The inkjet printing device according to claim 13, wherein an opening part of the plasma ejection port is oriented in the moving direction of the target base printing material.

17. The inkjet printing device according to claim 13, wherein a base material that is grounded or charged with negative electricity or positive electricity is placed, under the inkjet printing part, on a side of a non-printing surface opposite to the printing surface of the target base printing material in a manner contacting the non-printing surface side of the target base printing material when the target base printing material moves under the inkjet printing part.

18. The inkjet printing device according to claim 13, having a cover for covering the plasma ejection port.

19. An inkjet printing device comprising:
inkjet nozzles of a line-head type for printing one or more colored inks; and
plasma ejection ports, each provided for each of the inkjet nozzles, which is a color-specific nozzle, on a downstream side in the moving direction of a target base printing material.

20. An inkjet printing device comprising:
inkjet nozzles of a line-head type, which are constituted by one or more sets of inkjet nozzles, each set being for printing one or more colored inks; and
plasma ejection ports, each provided for each set of the inkjet nozzles for printing one or more colors on a downstream side, in the moving direction of a target base printing material, as viewed from the line-head nozzle.
